(19) United States
(12) Patent Application Publication
(10) Pub. No.: US 2014/0312635 A1
(43) Pub. Date: Oct. 23, 2014

(54) NON-PERMANENT CHILD RESISTANT CABINET RESTRAINT

(71) Applicants: Erik Hansen, San Diego, CA (US); Brad Matthew Damphousse, San Diego, CA (US)

(72) Inventors: Erik Hansen, San Diego, CA (US); Brad Matthew Damphousse, San Diego, CA (US)

(21) Appl. No.: 14/205,127

(22) Filed: Mar. 11, 2014

Related U.S. Application Data
(60) Provisional application No. 61/802,305, filed on Mar. 15, 2013.

(51) Int. Cl. E05C 17/54

(52) U.S. Cl. CPC E05C 17/54
USPC 292/343

(57) ABSTRACT

Systems and methods for dynamically adjusting the gain in a receiver front end. The gain is adjusted in order to make an error margin for each incoming signal essentially equal. Signals are initially received together. The signals are split in order to allow for independent adjustments to the gain of each signal. The signals are then gain adjusted. After gain adjustments are made, the signals are recombined.

### CROSS-REFERENCES TO RELATED PATENT APPLICATIONS

This application claims priority from United States provisional application entitled “Non-Permanent Child Cabinet Lock”, Ser. No. 61/802,305, filed 15 Mar. 2013, which is incorporated herein by reference.

### BACKGROUND

Embodiments of the claimed subject matter relate to furniture accessories, and more particularly to restraining devices for restraining cabinets and drawers to prevent children from accessing those cabinets and drawers. Other embodiments relate to methods for using the described non-permanent restraints with cabinets and drawers.

Typical child cabinet and drawer restraints available in the market today rely on permanent mountings to function properly. Many of these mountings require affixing the components of the child cabinet restraint to the cabinet door and/or the cabinet housing using screws or adhesive materials. This also applies to restraints for drawers. For the sake of brevity, the remainder of the discussion will refer to cabinets. However, it will be understood by those skilled in the art that the discussion applies to drawers and other enclosures as well.

For those people that do not own their home, permanently attaching child cabinet restraints to the cabinets using screws or adhesive materials could constitute damaging the cabinets, and may lead to violating terms and conditions in many lease agreements. It is important for parents and caretakers of children to guard against dangers that come from children accessing cabinets both in their own home, as well as the homes of people they may visit. Additionally, many child resistant cabinet restraints known in the prior art require that handheld or power tools be used for installation. Many parents and caretakers may not be familiar or comfortable with using such tools. Accordingly, there is a need for a non-permanent child resistant cabinet restraint.

### SUMMARY

A child resistant cabinet or drawer restraint is disclosed for temporary use on general household cabinets and drawers. In many embodiments, the restraint is made up of two interlocking pieces. In accordance with many such embodiments, the two interlocking pieces consist of a clip for installing the device on the cabinet door and a peg for engaging the cabinet frame. When the device is installed on the cabinet door, the restraint prevents the cabinet door from opening unless the person attempting to open the door knows the process to release the restraint. Cabinets and cabinet doors are referenced through this disclosure. However, it will be clear to those skilled in the art that the disclosure will apply equally to drawers.

A peg interlocks with a clip. The peg makes contact with a cabinet frame to prevent the door from opening more than a predetermined amount. The peg interlocks with the clip using interlock members. In one embodiment, the interlock members of the peg are one or more protrusions extending from the peg. Sliding the interlock members into corresponding interlocking members on the clip secures the peg to the clip. The interlocking members on the clip are recesses on the rear of the clip that secure the peg to the clip.

In one embodiment, several interlock members (e.g., protrusions) can be positioned to slide into corresponding interlocking members (e.g., recesses) on the rear of the clip. This secures the peg to the clip at a height that will allow the peg to catch the cabinet housing and prevents the door on which the clip is secured from opening. Accordingly, the restraint can be used with cabinet housings of different heights with respect to the top of the door.

In many of the described embodiments, the clip includes a flat front, an arched top, and a flat back. The restraint can be installed by sliding the clip over the top of a cabinet door with the adjustable recesses facing toward the inside of the cabinet. In these embodiments, the peg comprises a straight flexible arm extending from a base. The arm has a point at the end. A frame catch protrudes from the arm to engage the inside of the cabinet door when the cabinet is closed. In many of the embodiments, the interlock members used to connect the peg to the clip extend from the base of the peg. Alternatively, the peg may have recesses that interlock with protrusions on the clip. Other interlocking elements are also possible.

The described embodiments may be used with cabinets, such as those in a kitchens or garages. They may also be used with other furniture in homes or in vehicles (such as recreational vehicles and boats) as well with any items that have a door or flat panel type structure that can be opened to access an enclosed area and that can be closed to secure that area.

### BRIEF DESCRIPTION OF THE DRAWINGS

FIG. 1 is a side view of the clip according to an embodiment of the disclosed subject matter;

FIG. 2 is a front view of the clip according to an embodiment of the disclosed subject matter;

FIG. 3 is an opposite side view of the clip embodiment of FIG. 1;

FIG. 4 is the rear view of the clip according to an embodiment of the disclosed subject matter;

FIG. 5 is a front perspective view of the clip according to an embodiment of the disclosed subject matter;

FIG. 6 is a perspective view of the rear of a clip according to an embodiment of the disclosed subject matter;

FIG. 7 is a perspective view of the opposite side of the clip embodiment shown in FIG. 6;

FIG. 8. is a side view of the peg according to an embodiment of the disclosed subject matter;

FIG. 9 is a top view of the peg according to an embodiment of the disclosed subject matter;

FIG. 10 is a side perspective view of the peg according to an embodiment of the disclosed subject matter;

FIG. 11 is a side perspective view of the cabinet restraint showing the interlocking nature of the peg and the cabinet clip according to an embodiment of the disclosed subject matter; and

FIG. 12 is a side perspective view of the cabinet restraint showing the interlocking nature of the peg and the clip from the opposite side shown in FIG. 11.

FIG. 13 is a view of a portion of a front face of a clip in accordance with an alternative embodiment of the disclosed restraint.

FIG. 14 is an illustration of an alternative embodiment of the restraint having channels.

FIG. 15a is an illustration of a restraint installed on a door mounted on a cabinet frame.

FIG. 15b is an illustration of a restraint installed on a door.

FIG. 16 is a cut away view of a cabinet and the cabinet door with the restraint installed.

FIG. 17 is an illustration of a partially open door with a restraint installed.

### DETAILED DESCRIPTION OF THE EMBODIMENTS

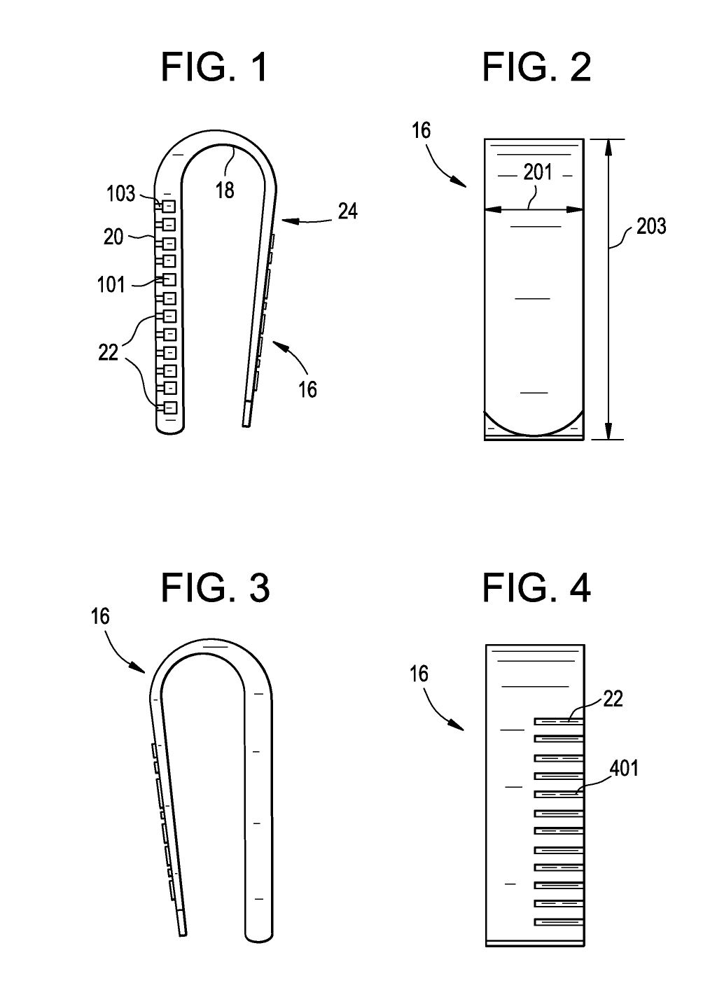

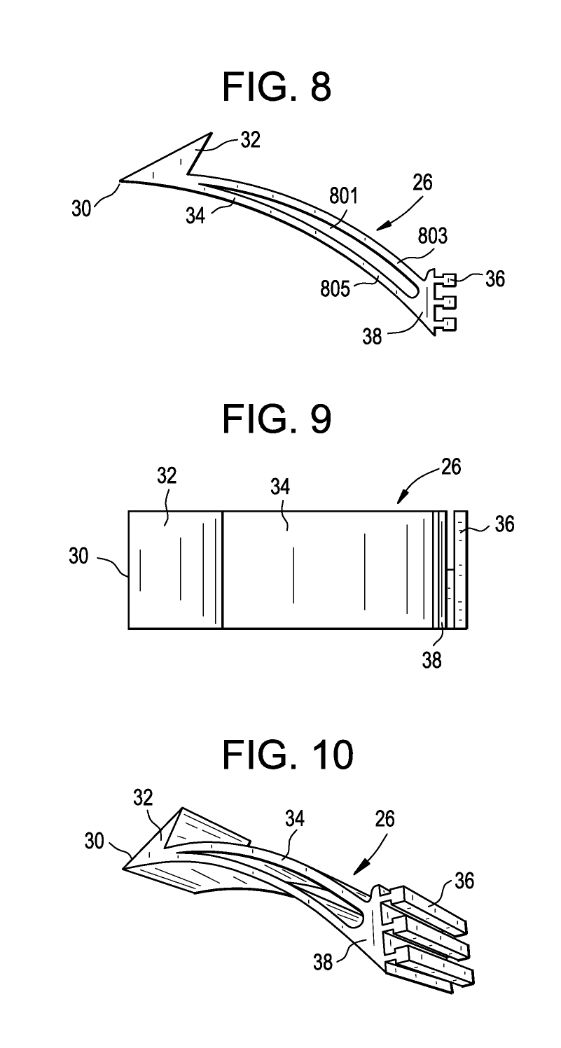

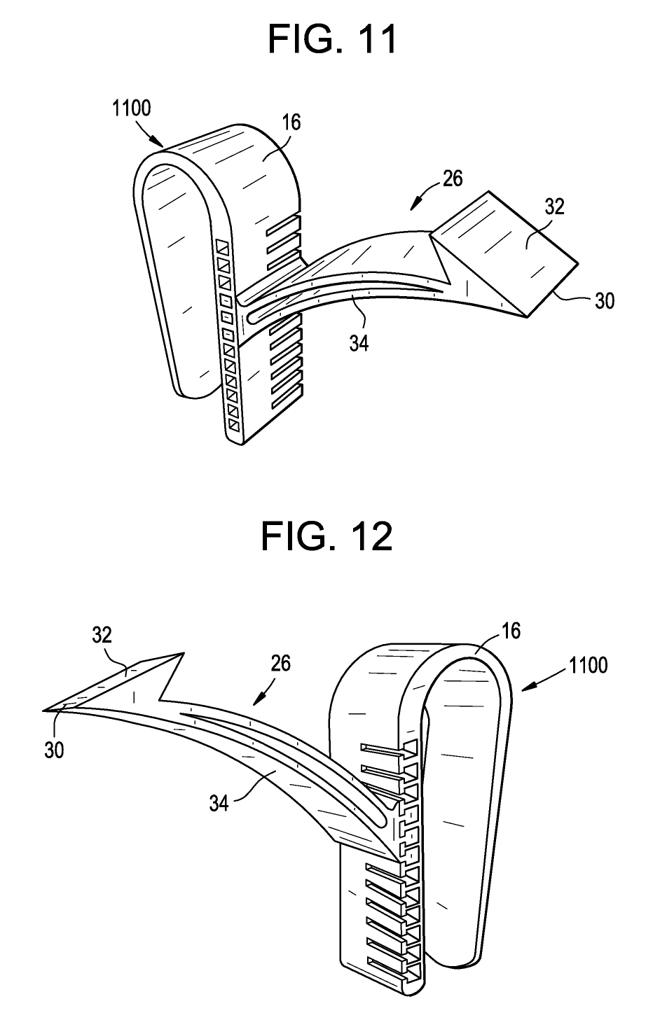

A non-permanent child resistant restraint is generally described with reference to FIGS. 1-13. FIGS. 1-13 show examples of embodiments of the disclosed subject matter. In the described embodiments, a restraint 1100 (shown in FIGS. 11 and 12) comprises a peg 26 (shown in FIG. 8) that interlocks with a clip 16 (shown in FIGS. 1-7, 11 and 12), as will be discussed in more detail further below.

In many of these embodiments, the clip 16 comprises a front face 20, a rear face 24 and a connecting section 18 between the front face 20 and rear face 24. The front face 20, rear face 24 and connection section 18 are configured to allow the clip to be hung on a panel, such as a door or drawer. In accordance with one embodiment, the clip 16 is approximately 1 to 2 inches wide 201, as shown in FIG. 2. In these embodiments, the clip 16 has a height 203 of approximately 4 inches. It will be understood by those skilled in the art that these dimensions may be altered to suit the dimensions of a particular cabinet or drawer with which the clip is intended to be used.

In many of the described embodiments, the clip 16 is constructed from a rigid plastic or polymer, a semi ridge polymer, metal, or hard rubber material. Any other suitable material that can be used, as will be known to those skilled in the art.

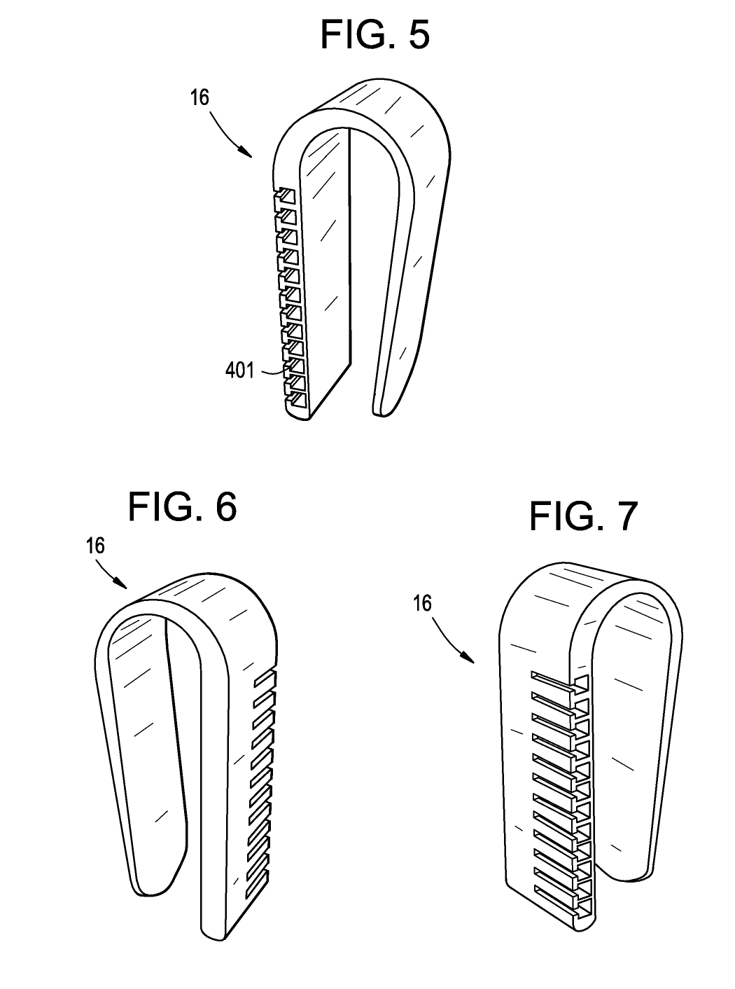

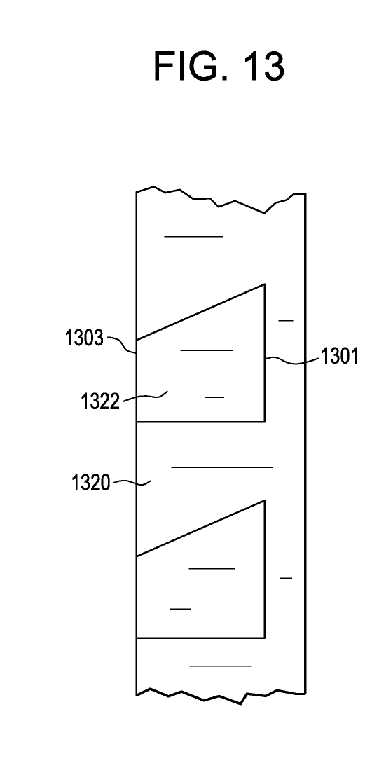

In the embodiments shown in FIGS. 1-7, the front face 20 includes at least one 2. In the particular embodiment of FIGS. 1-7, a plurality of interlock elements are provided. In this embodiment, the interlock elements are peg height adjustment slots 22. The adjustment slots 22 run from an opening 501 (see FIGS. 4 and 5) on one end of the clip 16 to approximately the center of the clip 16, as shown in FIG. 4. In these embodiments, each adjustment slot 22 comprises an approximately ⅛ inch×⅛ inch×1 inch rectangular interlock channel 101. Other dimensions may also be used to accomplish the same results in other embodiments. A second interlock channel opens to the front face 20. The second interlock channel is a smaller rectangular access channel 103. FIG. 13 shows an alternative shape for the peg height adjustment slot, which will be discussed in greater detail below.

These embodiments include the clip 16 in dimensions at minimum of 1 inch and at maximum of 2 inches wide from the front of clip 16, as shown in FIG. 2. In these embodiments, the clip 16 has a height of no more than 4 inches and a width of a minimum 1 inch wide up to a maximum of 3 inches wide. Adjustment slots 22 extend 50% of the distance of the total width as shown in FIG. 2 with adjustment slots 22 having approximately of ⅛ inch square. However, in an alternative embodiment, the adjustment slots 22 are made larger. These dimensions may also be altered as desired by those skilled in the art to accommodate varying sized of cabinets or other furniture or non-furniture being used with the embodiments.

In many of these embodiments, clip 16 can be constructed of a rigid plastic/polymer, a semi ridged polymer, a metal, a hard rubber material, or any other suitable material known to those skilled in the art with similar properties.

FIGS. 8-10 show a peg 26 having a base 38 with interlock elements, flexible arm 34, point 30, and frame catch 32.

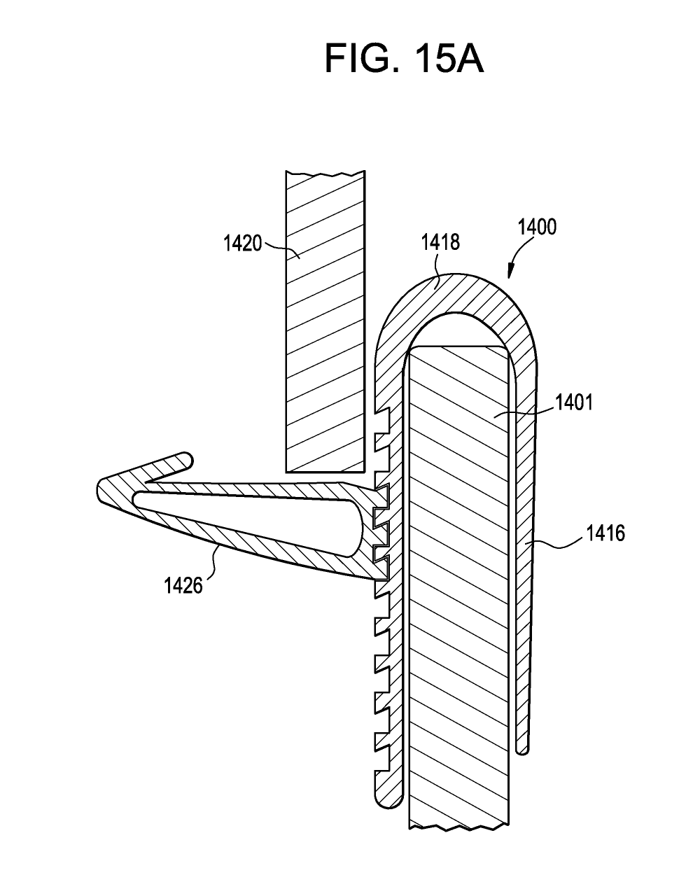

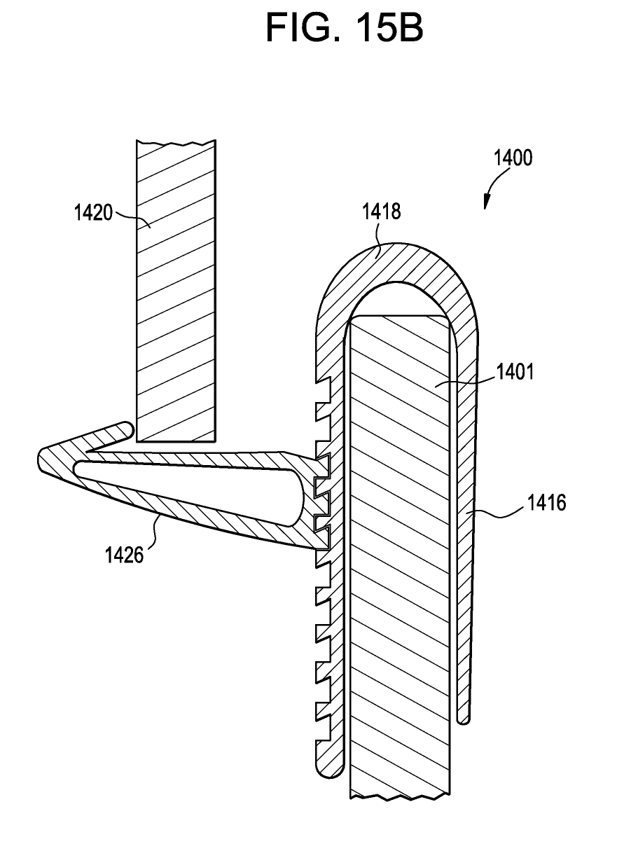

The interlock elements are located on the base 38 of the peg 26. In the embodiment shown in FIGS. 8-10, the interlock elements are protrusions 36 that interlock with the peg adjustment slots 22 at an appropriate height to allow the point 30 to clear the frame of the cabinet. That is, the clip has a plurality of interlock elements which allow the peg to interlock to the clip at any one of several heights. The height of the peg should be set to ensure that the restraint will engage. That is, the frame catch 32 should securely contact the inside of the cabinet frame once the point 30 clears the entry plane of the cabinet frame (see FIGS. 15a, 15b). To release the catch 32, the cabinet door is opened until the frame catch 32 comes in contact with the inside of the cabinet frame. The flexible arm 34 can then be depressed with sufficient force to allow the frame catch 32 to drop below and clear the cabinet frame, thus disengaging the restraint so that the cabinet door can be opened further.

In FIGS. 8-10, the width of peg 26 equals the width of clip 16. In some of these embodiments, the width of peg 26 is a minimum of 3 inches and a maximum of 5 inches although these dimensions may be altered as desired to accommodate varying sizes of items being used with the embodiments and/or to accommodate varying sizes of the embodiments themselves. In one alternative embodiment, the clip is 1.25″ wide and the peg is 0.5″ wide. The components of these embodiments may also be constructed of a rigid plastic/polymer, a semi ridged polymer, a metal, a hard rubber material, or any other suitable material known to those skilled in the art with similar properties.

The arm 34 is made to be flexible by both the shape of the arm 34 and the use of a center area 801 that is generally hollowed or formed to create space between an upper portion 803 and a lower portion 805 of the arm 34. The particular shape and size of the center area 801 can be varied to create a desired amount of flexibility while maintaining sufficient structural integrity and creating sufficient tension when in use to ensure that the frame catch 32 will remain securely in contact with the cabinet frame when the restraint is engaged.

FIGS. 11 and 12 show the peg 26 interlocked with the clip 16 at approximately the mid adjustment height. The three protrusions 36 on the base of the arm 34 slide into the channels 101, 103 in the clip 16 to removably secure the arm 34 to the clip 16.

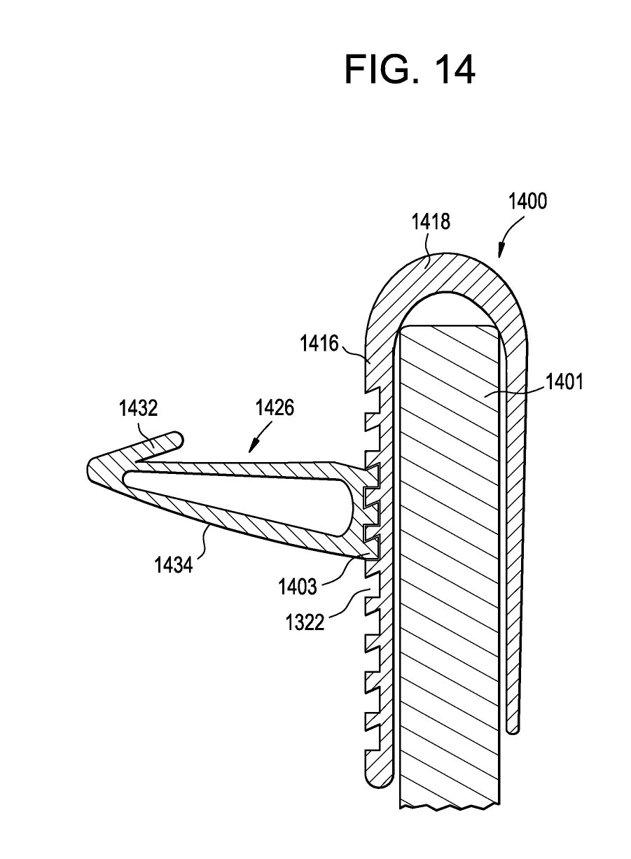

FIG. 13 is a cut away view of a portion of a face 1320 of a clip in accordance with one embodiment of the disclosed restraint. It shows an alternative shape for the channels used to interlock a peg 1436 to a clip 1416 (see FIG. 14). Channels 1322 within the face 1320 are shaped to capture interlock elements, which as shown in FIG. 13, are protrusions 1403 from a peg 1426. The channel 1322 is open at one end and along the length of the channel 1322. The height of the channel increases with distance from the opening along the length. Accordingly, the back 1301 of the channel is longer than the open front 1303 of the channel.

FIG. 14 shows an alternative embodiment of the restraint having channels 1322. As shown, a restraint 1400 has a clip 1416 and a peg 1426. The clip 1416 has a connecting section 1418. The inside surface of the connection section 1418 comes in contact with the top edge of a cabinet door 1401 when the clip 1416 is slid into place over the top of the door 1401. The peg 1426 comprises a flexible arm 1434. The arm 1432 has a frame catch 1432.

FIG. 15a shows the restraint 1400 installed on a door 1401 mounted on a cabinet frame 1420. As shown, the door 1401 is closed. That is, the door 1401 is essentially in contact with the cabinet frame 1420 along the entire perimeter of the door 1401. As shown in FIG. 15b, if a child should attempt to open the door 1401, the door 1401 and the restraint 1400 will move to the right. The cabinet frame 1420 remains stationary. The peg 1426 will slip underneath the cabinet frame 1420, but will prevent the door 1401 from opening beyond the point at which the frame catch 1434 comes into contact with the cabinet frame 1420 (see FIG. 15b) and the restraint will engage.

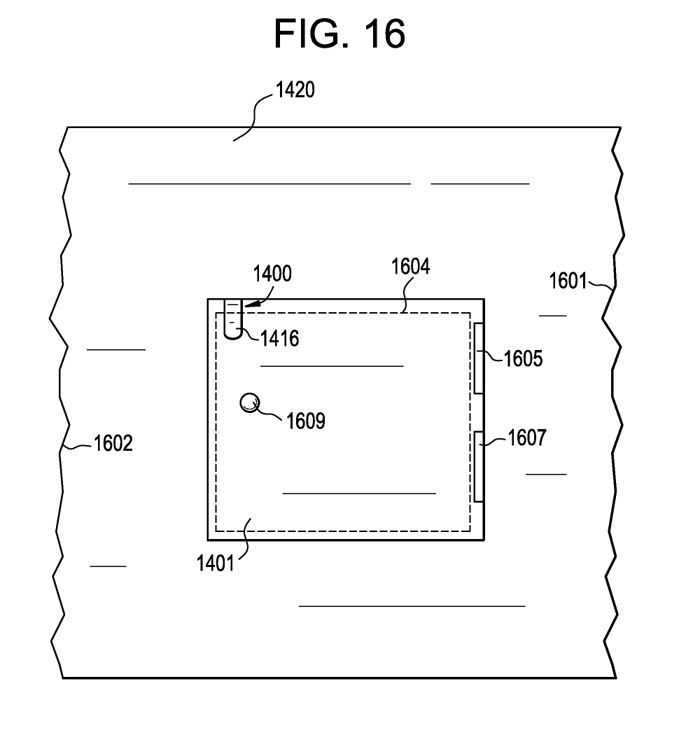

FIG. 16 shows a cut away view of a cabinet and the cabinet door 1401 with the restraint 1400 installed. The door 1401 is shown closed. The cabinet frame 1420 is shown cut off at two sides 1601, 1602. A dotted line 1604 indicates the perimeter of the cabinet opening. The door 1401 is hung on two hinges 1605, 1607. The door 1401 has a handle 1609 to allow a user to open the door 1401. When the restraint 1400 is disengaged, the door 1401 can be opened by pulling the handle 1609.

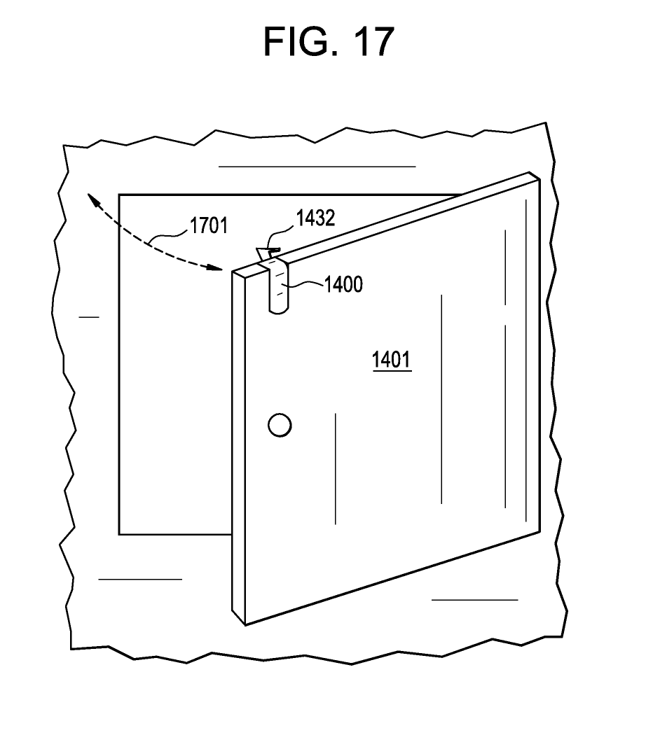

FIG. 17 shows the door 1401 partially open. A dotted arc 1701 shows the travel of the door 1401 as it swings open and closed. The restraint 1400 is installed on the door 1401. The frame catch 1432 is shown extending from the peg. With the door 1401 partially open, the frame catch 1432 is not engaged with the cabinet frame 1420.

As can be seen, various disclosed restraint embodiments can be used to keep children out of cabinets without a permanent installation. It should also be clear that several variations are possible, such as variations in the particular shape of the slots and the channels that make up the slots that capture the protrusions. In one variation, the channels run perpendicular to the channels 101, 103 shown in FIG. 4. This would restrict the ability of the user to adjust the height of the frame catch, but other means to allow for such adjustments will become apparent to those skilled in the art, such as using removable spacers to partially fill the channels and thus raise the peg, etc. Such variations, while less desirable in some instances, are within the scope of the present disclosure.

It will be clear to those skilled in the art that several other such variations are possible and would fall within the scope of the present disclosure. Likewise, the particular shape of the arm and frame catch can vary significantly from that disclosed herein without falling outside the scope of the present disclosure. For example, the arm 34 can be made solid (without the hollow center section 801). Furthermore, the radius of the curve of the arm 34 can vary significantly. Furthermore, the frame catch can be generally pointed, rounded, generally rectangular, etc.

In several embodiments, the restraint installs quickly and without the need for additional tools. In these embodiments, the restraint can be installed without defacing surface of the cabinet. Therefore, no damage or harm is done to the door or to the cabinet frame. The peg can be secured to the clip in several different positions, allowing the restraint to be used on cabinet frames of various heights. When a user wants to restrain the cabinet door, the user closes the door normally. The peg will catch the top of the cabinet frame thereby allowing the door to close flush. If the peg does not catch the frame, the user can raise the peg using the described adjustment system until it does catch. When the user wishes to disengage the restraint, the user opens the cabinet door until the peg engages the cabinet restraint. The user then able depresses the arm until the peg's clasp clears the cabinet frame, allowing the door to be opened.

Although the foregoing embodiments have been described in some detail by way of illustration and example for purposes of clarity and understanding, it will be apparent to those of ordinary skill in the art in light of the teaching of this disclosed subject matter that certain changes and modifications may be made thereto without departing from the spirit or scope of the appended claims. For example, the described restraints may be used with any portable or non portable apparatus have two opposing surfaces such as a box, safe, polymer container or fabric panels in both fixed and non fixed locations such as trailers and portable storage containers.

What is claimed is:

1. A restraint comprising:
a) a clip having at least one first interlock element a front face a rear face and a connecting section between the front face and the rear face, the front face, rear face and connecting section configured to allow the clip to be hung on a panel; and
b) a peg having an arm, a base, at least one second interlock element and a frame catch, the second interlock element configured to interlock with the first interlock element.

2. The restraint of claim 1, wherein the first interlock element is a slot on the front face of the clip and the second interlock element is a protrusion from the base, of the peg.

3. The restraint of claim 2, wherein the slot is comprised of a first channel having an opening on one end of the front face that runs the length of the channel along the front face of the clip and into which the protrusion is slid to interlock the peg to the clip and thus secure the peg to the clip.

4. The restraint of claim 3, wherein the slot comprises a second channel, the second channel being larger than the first channel.

5. The restraint of claim 2, wherein the back of the channel is longer than the open front of the channel.

6. The restraint of claim 1, the clip having a plurality of first interlock elements which allow the peg to interlock to the clip at any one of several heights.
